(19) United States
(12) Patent Application Publication
(10) Pub. No.: US 2004/0174675 A1
(43) Pub. Date: Sep. 9, 2004

(54) Book-style computer attachable to LCD monitor

(76) Inventor: Ming-Tson Liu, Taipei (TW)

Correspondence Address: SUPREME PATENT SERVICES, POST OFFICE BOX 2339, SARATOGA, CA, 95070, US

(21) Appl. No.: 10/384,516

(22) Filed: Mar. 6, 2003

(51) Int. Cl. G06F 1/20

(52) U.S. Cl. 361/687; 361/686; 361/681

(57) ABSTRACT

A book-style computer attachable to an LCD monitor has a locking portion in conformity with the VESA (Video Electronics Standards Association) standards such that the book-style computer is attachable to the backside of a generic LCD monitor. The book-style computer is comprised of a front lid, an operation portion, a rear closure, and a heat-dissipation portion, and is characterized in: all the through holes being in conformity with the VESA standards to allow the computer to be fixed in the backside of the LCD monitor, and the heat-dissipation portion further comprising a bottom plate, a leaf-style heat sink, and a laterally blowing fan. A CPU main board is characterized in that a heat generation unit is attached on the bottom plate of the leaf-style heat sink while other components are installed on the other side of the CPU main board.

### FIELD OF THE INVENTION

This invention is proposed to provide a book-style computer, more specifically, a book-style computer attachable to a Liquid Crystal Display (LCD) monitor.

### BACKGROUND OF THE INVENTION

Because of relatively light in weight and small in volume, the LCD monitor has been popularized since couple years ago to lead a tide of substituting for the conventional CRT monitor of a personal computer (PC).

The existing PC based on an LCD monitor could generally be classified into two categories: one having integrated the CPU main board of a PC together with an LCD screen as a unitary body, which can hardly catch the updating speed of today's CPUs, and it might have a problematic efficiency on heat dissipation and noise; and the other being a simple combination of a separated PC and an LCD monitor, which is rather bulky and cumbersome irrespective of a tower PC or a desktop PC.

In view of abovesaid defects, this invention is proposed to provide an external computer for solving the problems in updating, poor heat-dissipation efficiency, and noise. The specific computer of this invention is designed to mate with an LCD monitor in market, either in a wall-hanging type or cantilever type, without occupying much space to thereby keep an omni-functional PC with a sightly appearance.

### SUMMARY OF THE INVENTION

The primary objective of this invention is to provide a space savable computer for solving the problematic bulky volume of a generic personal computer (PC).

Another objective of this invention is to provide an exclusive computer for LCD monitor, which can be updated easily for solving the updating problem of a generic computer.

Yet another objective of this invention is to provide a computer with high efficiency in heat dissipation and noise elimination for solving the problematic heat dissipation and noise in a generic LCD computer.

In order to realize above-said objectives, a book-style computer embeddable in LCD monitor of this invention has a locking portion in conformity with the VESA (Video Electronics Standards Association) standards such that the book-style computer is attachable to the backside of a generic LCD monitor. This computer is comprised of a front lid, an operation portion, a rear closure, and a heat-dissipation portion, and is characterized in: all the through holes being in conformity with the VESA standards to allow the computer to be fixed in the backside of an LCD monitor, the heat-dissipation portion further comprising a bottom plate, a leaf-style heat sink, and a laterally blowing fan. The heat-dissipation portion has a plurality of through holes in conformity with the VESA standards such that it can be locked in the backside of an LCD monitor. Both the front lid and the rear closure are made of a metallic material or plastic material having electrically conductive painting elements, which can shield high-frequency rays and can be configured diversely. The operation portion is installed in a longitudinal space formed between the front lid and the rear closure, and is substantially a CPU main board having through holes in conformity with the VESA standards to allow it to be fixed in the backside of the LCD monitor. The CPU main board is characterized in that a heat generation unit is attached on the bottom plate of the leaf-style heat sink while other components are installed on the other side of the CPU main board.

This invention is an external computer of a specific design and is provided for the purpose of solving the problems regarding updating, heat dissipating, and noise generating. Moreover, it can mate with most of the LCD monitors without occupying any extra space, irrespective of a wall-hanging type or a cantilever type, which can be found in the market to thus accomplish an omni-functional personal computer.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 is a lateral view of a conventional LCD monitor;

FIG. 2 is a lateral view of a book-style computer of this invention attachable to an LCD monitor;

FIG. 3 is an exploded view of the book-style computer of this invention attachable to an LCD monitor;

FIG. 4 is a schematic view showing that a wall-hanging lever is arranged for holding this computer set after this invention is fixedly locked in the backside of an LCD monitor,

FIG. 5 is a schematic view showing that a cantilever is arranged for holding this computer set after this invention is fixedly locked in the backside of an LCD monitor, and

FIG. 6 shows a laterally blowing fan employed in this invention.

### DETAILED DESCRIPTION OF THE PREFERRED EMBODIMENT

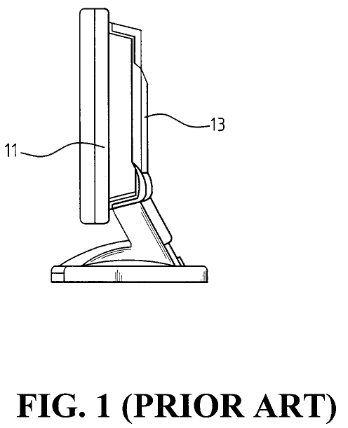

FIG. 1 is a lateral view of a conventional LCD monitor. For the sake of hanging or holding a thin LCD monitor 11 on wall or with a cantilever, there are some specification standards enacted by Video Electronics Standards Association (VESA), in which a fixing portion 13 having four mounting holes is defined in the backside of an LCD monitor such that a personal computer (PC) could be carried on the back of the LCD monitor to become an omni-functional LCD computer.

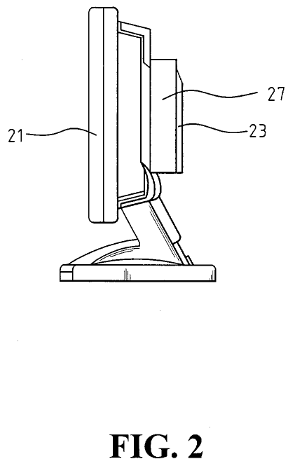

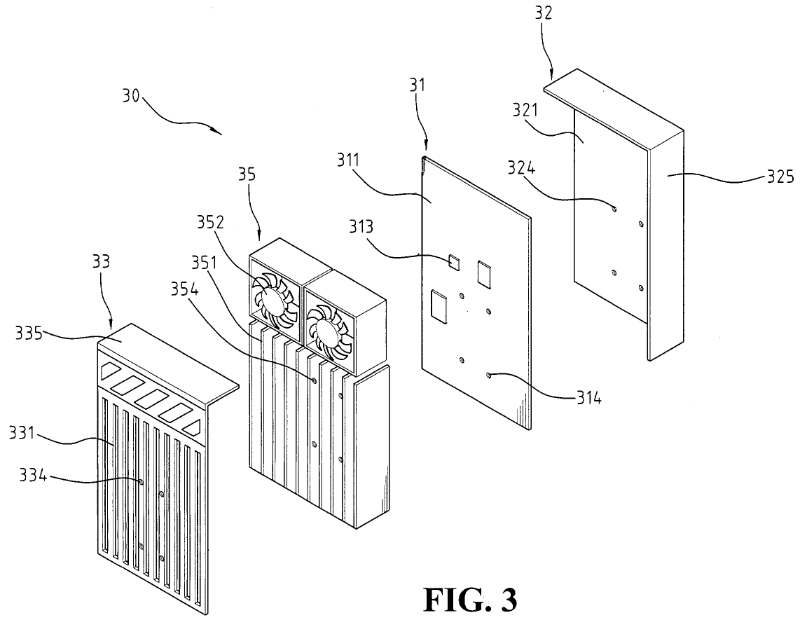

FIG. 2 is a lateral view of a book-style computer of this invention attachable to an LCD monitor. A book-style computer 27 of this invention has a locking portion (shown in FIG. 3) conforming to the VESA standards so that the computer 27 could be locked to the backside of a generic LCD monitor 21 and hence fixed in between a back plate of the LCD and a fixing portion 23 by means of a stud bolt.

FIG. 3 is an exploded view of the book-style computer of this invention attachable to an LCD monitor. The book-style computer 30 of this invention is comprised of a front lid 32, an operation portion 31, a rear closure 33, and a heat-dissipation portion 35, in which the front lid 32 further comprises a bottom plate of front lid 321 and a vertical side jamb 325, in which the bottom plate of front lid 321 has a plurality of through holes 324 conforming to the VESA standards for fixing the computer 30 at the backside of the LCD monitor. The operation portion 31 is installed in a longitudinal space formed between the front lid 32 and the rear closure 33 and is comprised of mainly CPU main board 311 having a plurality of through holes 314 conforming to the VESA standards for being locked in the backside of an LCD monitor. The CPU main board 311 is characterized in that a heat-generation unit 313 is attached closely to a base plate of a leaf-style heat sink 351 while the rest components are installed on the other side of the CPU main board 311. The heat-dissipation portion 35 having a plurality of through holes 354 conforming to the VESA standards for being locked in the backside of an LCD monitor is comprised of a bottom plate (not shown), the leaf-style heat sink 351 and a laterally blowing fan 352.

The leaf-style heat sink 351 might take advantage of its copper bottom plate to get attached to the heat-generation unit 313 of the CPU main board 311.

The heat-generation unit 313 could be a central processing unit (CPU) or any other high-speed operation chipset.

The rear closure 33 further comprises a bottom plate of rear closure 331 and a vertical side jamb 335, in which the bottom plate of rear closure 331 has a plurality of through holes 334 in conformity with the VESA standards to allow the bottom plate of rear closure 331 to be locked in the backside of an LCD monitor. After this invention is locked in the backside of an LCD monitor, the combination may use a wall-hanging lever or a cantilever to become an LCD computer in diversified forms.

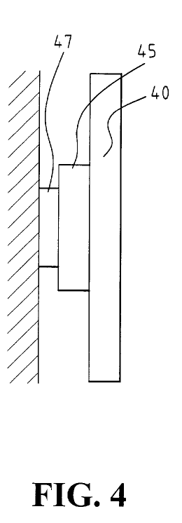

FIG. 4 is a schematic view showing that a wall-hanging lever is arranged for holding this computer set after this invention is fixedly locked in the backside of an LCD monitor. After an LCD monitor 40 is locked together with a book-style computer 45 of this invention, the combined LCD computer could be hanged on any upright wall by means of a wall-hanging lever 47 in conformity with the VESA standards.

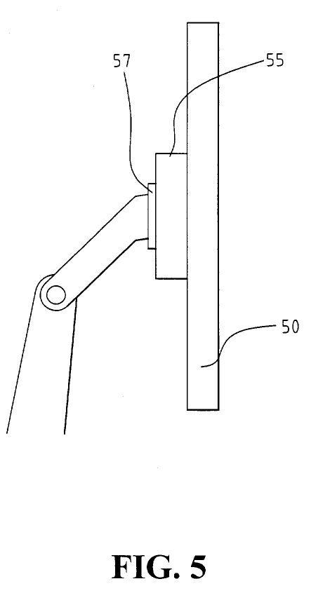

FIG. 5 is a schematic view showing that a cantilever is arranged for holding this computer set after this invention is fixedly locked in the backside of an LCD monitor. After an LCD monitor 50 is locked together with a book-style computer 55 of this invention, the combined LCD computer could be a cantilever computer by means of a cantilever 57 in conformity with the VESA standards.

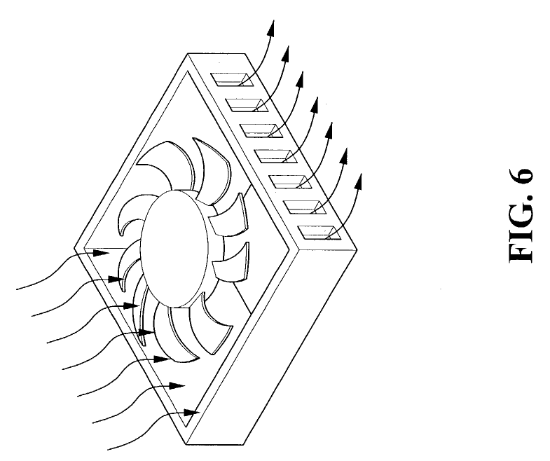

FIG. 6 shows a laterally blowing fan employed in this invention. The laterally blowing fan is so flat shaped for application in the book-style computer that the volume of this invention won't be bulged, and moreover, air is sucked through the upper portion of the fan and blown laterally.

In the above described, at least one preferred embodiment has been described in detail with reference to the drawings annexed, and it is apparent that numerous changes or modifications may be made without departing from the true spirit and scope thereof, as set forth in the claims below.

What is claimed is:

1. A book-style computer attachable to a liquid crystal display (LCD) monitor, having a locking portion in conformity with the VESA (Video Electronics Standards Association) standards to allow said locking portion to be locked in the backside of a generic LCD monitor; the book-style computer being comprised of a front portion, an operation portion, a rear closure, and a heat-dissipation portion, and characterized in that:
all the related portions having through holes are fully in conformity with the VESA standards to allow the computer to be fixed in the backside of an LCD monitor,
said heat-dissipation portion has a bottom plate, a leaf-style heat sink, and a laterally blowing fan, and also a plurality of through holes in conformity with the VESA standards such that said heat-dissipation portion can be fixedly locked in the backside of an LCD monitor;
both the front lid and the rear closure are made of a metallic material or plastic material having electrically conductive painting elements, which can shield high-frequency rays and can be configured diversely;
said operation portion is installed in a longitudinal space formed between the front lid and the rear closure, and is substantially a CPU main board having through holes in conformity with the VESA standards to allow itself to be locked to the backside of an LCD monitor; and
said CPU main board is characterized in that a heat generation unit is attached closely on the bottom plate of the leaf-style heat sink while other components are installed on the other side of said CPU main board.

2. The book-style computer according to claim 1, wherein said leaf-style heat sink takes advantage of its copper bottom plate to get attached to the heat-generation unit of said CPU main board and also of the laterally blowing fan to facilitate the heat dissipation of the large-area lateral heat sink.

3. The book-style computer according to claim 1, wherein said heat-generation unit is a CPU and/or a system chipset.
